(19) United States
(12) Patent Application Publication
(10) Pub. No.: US 2002/0104560 A1
(43) Pub. Date: Aug. 8, 2002

(54) Fish stick and survival stick

(76) Inventor: David Kelley, Ventura, CA (US)

Correspondence Address: David Kelley, 143 N. Encina 1 Ave., Ojal, CA, 93023, US

(21) Appl. No.: 09/776,866

(22) Filed: Feb. 5, 2001

(51) Int. Cl. A45B 3/00; A01K 97/08

(52) U.S. Cl. 135/66; 135/18; 43/26; 224/922; 206/315.11

(57) ABSTRACT

Five pieces of aluminum from 1 in. diameter 14 inches long starting starting at the bottom, and then 1⅛ diameter 14 inches long, going into 1¼ inches to 1⅜, and these are three inches long, going to the handle which is a 1½ diameter and 36 inches long. Thus making up part #2 of FIG. 1. These connections are also shown in FIGS. 6, 2a, -2e. The tubes of aluminum in the possessions on FIG. 6 and FIG. 7 are the cut that go around the tubing are welded and that welding bead is then ground smooth, as welding joints.

The body of the unit is then powder coated, then a plastic cap is inserted and a rubber tip is put on the end of the one inch diameter aluminum tubing as in FIGS. 7 and 1.

The unit also comes with a foam handle grip, approximate wall thickness of handle grip is ⅛ inch thick., and is 20 inches long. See FIG. 1 #3.

The unit has a wooden or plastic cap with a rubber stopper that fits snuggly into the top opening of the 1½ inch aluminum tubing. Making this the top opening of the unit, as seen on FIGS. 1, 4 and 5

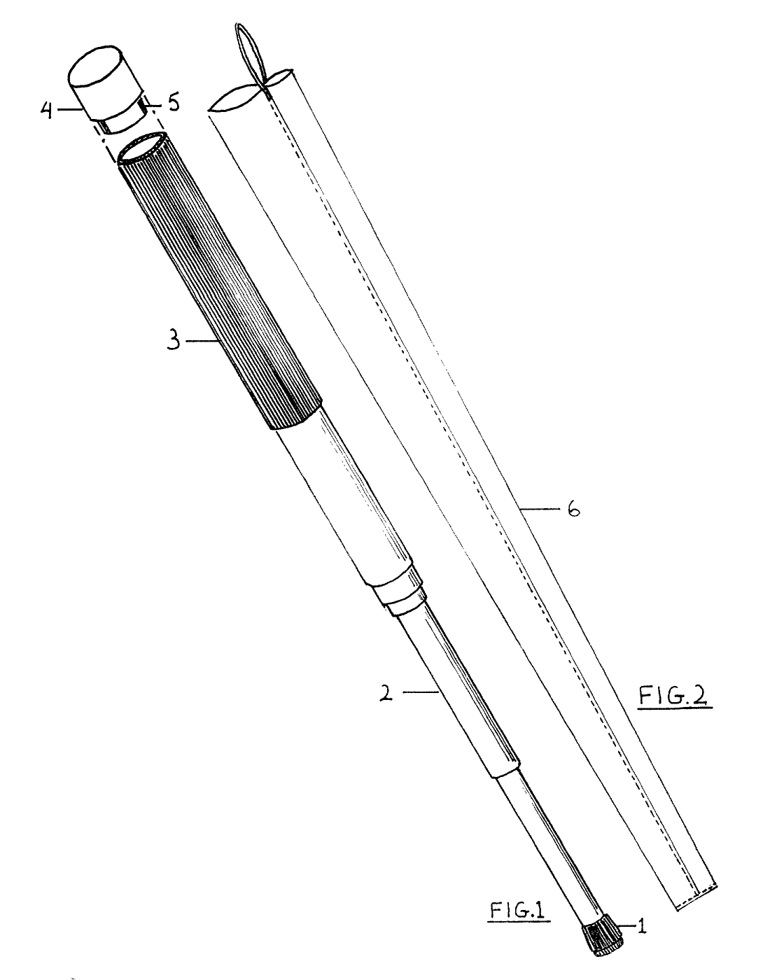

The unit also has a cloth liner that will fit inside the unit. Thereby protecting what is placed inside, as seen in FIG. 2, #6.

### BACKGROUND

This inventions relates to outdoor equipment. Specifically to the transportation of fishing or first aid equipment.

### PRIOR ART

On a camping trip that included a fly fishing excursion, I found while tracking through the woods that my fly-rod was a constant source of worry. The fly-rod case I Was using was not adequate to protect the pole. It was quite cumbersome as well.

Once at home I looked for something to solve this problem. There was nothing better than what I already had. I solved this by making is ridged compartment capable of sustaining the strain of a grown man, complete with a fully loaded back-pack. The end result is simple but very effective.

fly-rod was a constant source of worry. The fly-rod case I was using was not adequate to protect the pole. It was quite cumbersome as well.

### RAMIFICATIONS

The Fish Stick by Kelley Innovations is a tapering aluminum pole with a hard rubber end cap and a soft rubber or leather hand grip. With a tightly fitting cap (plain or carved) held in place by more rubber fitted down inside of the tube. The Fish Stick was designed and created to provide a safe, easy to use method for the transport of a fly-rod.

This new idea was born after a camping trip with a conventional fly-rod case. The standard case was awkward as it would get caught or hung up while walking on trails or through the brush. The Fish Stick provides a helpful way to enjoy the outdoors by doubling as a walking stick and a fly-rod case.

The Survival Stick is made by the same high quality standards as The Fish Stick. The Survival Stick has a compass set down into the lid cap. The inside liner can hold a multitude of emergency supplies. For example: a silver foil blanket, pain/fever reducers, water purification tablets, a snake bite kit, waterproof matches, a flare and a booklet on basic survival techniques. There is also space for your personal supplies.

Once again, you would not only have an excellent walking stick but you also have the added knowledge that you are prepared for most difficulties that may arise.

Ramifications for FIGS. are the same for FIGS. except that the bodies are made from a single piece of aluminum, thereby negating the need for multiple pieces of welded aluminum. This solid frame construction can of course, be used on both The Fish Stick and The Survival Stick.

### DESCRIPTION

FIG. 1 is a perspective view of the Fish Stick, fly rod case-walking staff.

FIG. 2 is the protective bag for fly rod.

FIG. 3 is a cross section drawing of top portion of Fish Stick showing the aluminum shaft (2) with foam rubber handle grip (3), wood cap (4), rubber seal (5), washer (6), and screw (7).

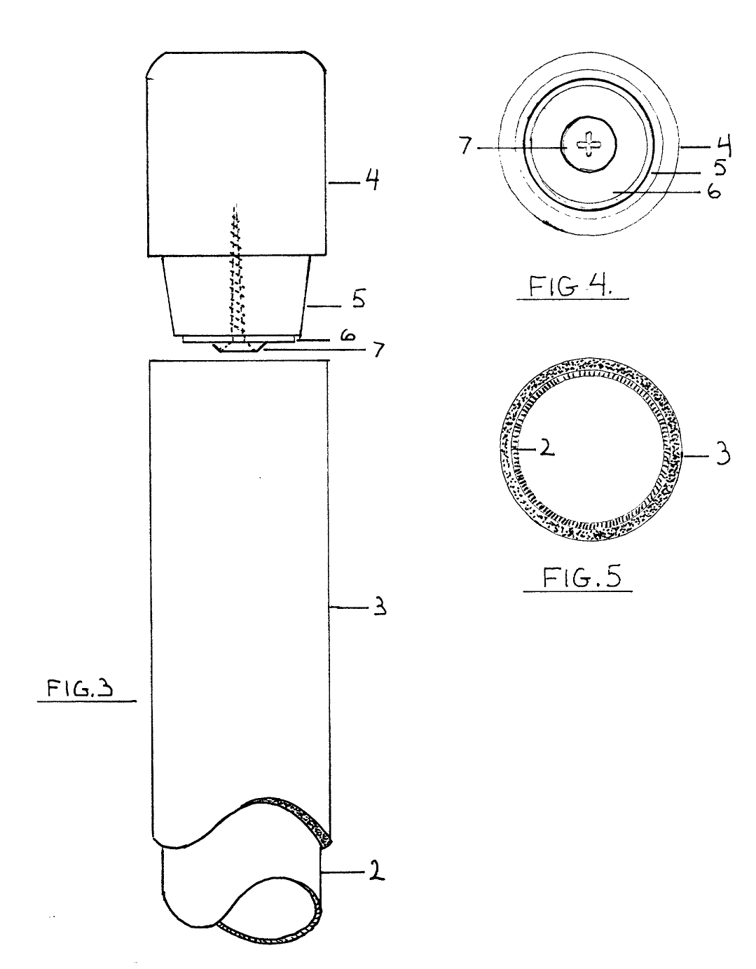

FIG. 4 is the bottom view of the wood cap (4), rubber seal (5), washer (6), and screw (7).

FIG. 5 is a cut away of the aluminum shaft (2) with foam rubber handle grip (3).

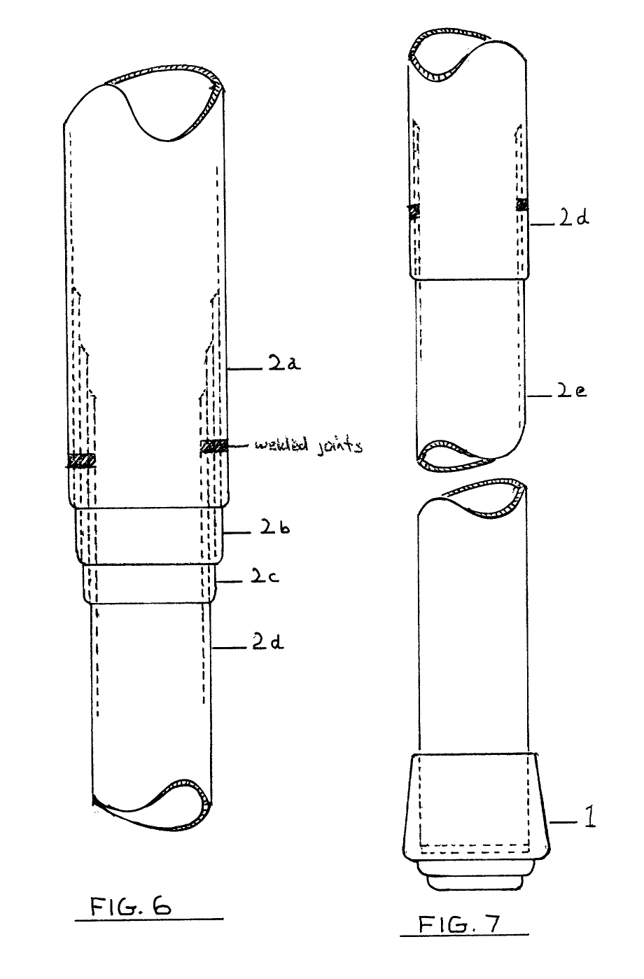

FIG. 6 is a cut away view of the top portion of the aluminum shaft. Numbers 2a through 2d show the aluminum tubing reducing from 1 and ½ inches (2a) to 1 and ⅜ inches (2b) to 1 and ¼ inches (2c) to 1 and ⅛ inches (2d). Also shown are the welded joints.

FIG. 7 is a cut away view of the bottom portion of the aluminum shaft. Numbers 2d and 2e show the final reduction of tube size to 1 inch. Number 1 being a hard rubber tip.

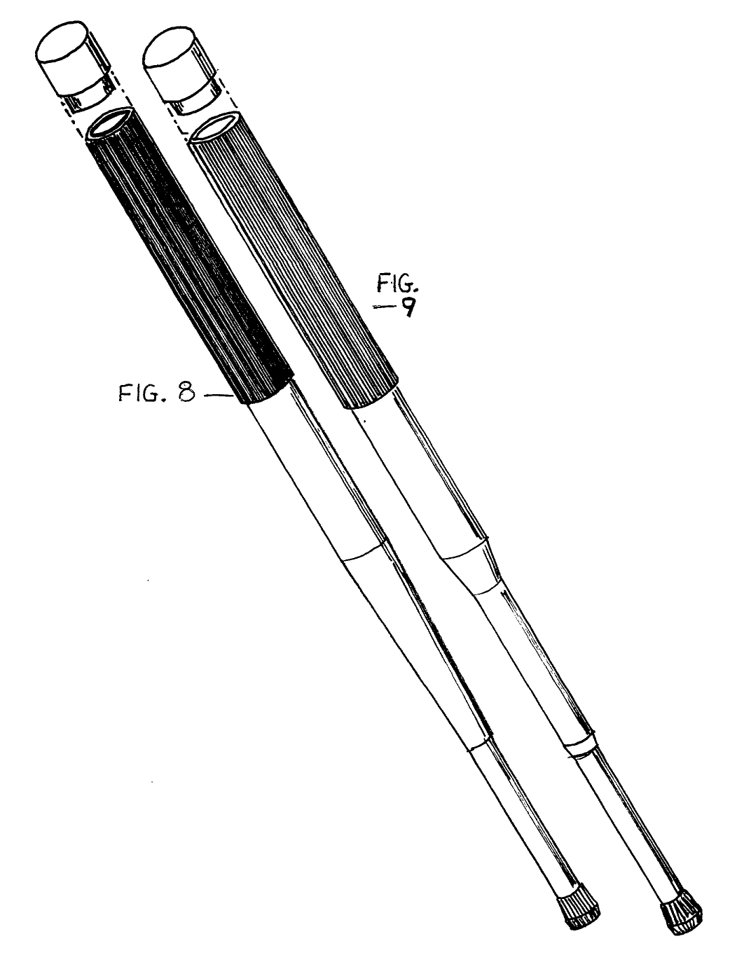

FIGS. 8-9 show comparison sketches of future Fish Stick renditions being extruded (8) instead of welded (9), producing a seamless product (8) in place of the welded joints

### OBJECTS AND ADVANTAGES

Accordingly several objects and advantages of my inventions are that it provides an aid in walking or hiking. And it provides a safe, secure method for transporting a fly fishing rod. It's ease of use and durability are not currently available.

Conventional fly-rod cases are not designed to withstand the stresses that can be put on them. This can be a real problem as the result means a damaged or broken fly-rod.

Also the fly-rod cases that are available now need to be held or packed. Carrying said cases means that one hand is constantly occupied and in no way provides leverage or balance. To pack a case in means to deal with it getting hung up on trees or other brush. Packing your fly-rod case also means adding weight and unnecessary bulk.

This idea can be converted quite effectively to hold first aid supplies rather than a fly-rod. With the same design, one can have the benefits of a walking stick and the convenience of an easy to access emergency supply system.

Normally first aid supplies are difficult to get to quickly. This is due to the fact that they are tightly packed in and around many other items. The object of this new adaptation is speed of accessibility and ease of use.

It can also be used in emergency situations as it can store objects a person might need if stranded or lost. Again, this idea is simple but effective.

So far everyone that we have shone these products to has been excited to see them. There are people who already wish to buy this new product idea.

### ADVANTAGES/DISADVANTAGES

The disadvantages to all standard caring cases for fly-rods is that they not only take up valuable space, but they add weight when packed. They are also frustratingly good at getting hung up on any available tree limb or bush. Even on a trail. Given the high demand for expensive fly -rods, safe and stable transport is not always attainable No fly-rod case sold today is designed to handle the stresses delivered while leaning, hiking or occasionally falling down. The Fish Stick solves this problem beautifully by providing a safe and comfortable housing for your fly-rod.

Many people who enjoy camping and hiking buy walking sticks. And no one who goes camping or even out for a day hike should do so without bringing a first aid kit along. It is as important as water when your out in the wilderness.

Conventional walking sticks only provide balance and support. The Survival Stick has many advantages over traditional walking sticks. My design provides the user with a tool that allows for quick and reliable access to first aid or emergency equipment. Weather it is simply retrieving pain reliever or if you should find yourself in a more serious situation, you'll be glad to have The Survival Stick along. Everything you need from a band aid to a flare, you will have literally at arms length.

1. A method for transporting a fly fishing rod or back-packing; survival equipment
1.) an elongated tube which tapers down at one end to the size of a conventional walking stick with a rubber tip at the small end and a larger cap at the wide, top most end
2.) adding a thin cloth bag (or bags) which fits inside to the length of the tube, allowing items to be placed inside to prevent damage also
3.) providing a comfortable hand grip on the outside of the large end, or top of the unit
Whereby providing a convenient, practical and highly dependable means for walking hiking and transporting important outdoors equipment:
